(19) United States
(12) Patent Application Publication
(10) Pub. No.: US 2007/0139424 A1
(43) Pub. Date: Jun. 21, 2007

(54) DSP System With Multi-Tier Accelerator Architecture and Method for Operating The Same

(76) Inventor: Ivo Tousek, Stockholm (SE)

Correspondence Address: BAKER & MCKENZIE LLP;PATENT DEPARTMENT, 2001 ROSS AVENUE, SUITE 2300, DALLAS, TX, 75201, US

(21) Appl. No.: 11/613,170

(22) Filed: Dec. 19, 2006

Related U.S. Application Data
(60) Provisional application No. 60/751,626, filed on Dec. 19, 2005.

(51) Int. Cl. G06F 15/16

(52) U.S. Cl. 345/503

(57) ABSTRACT

In a DSP system, a processor accesses a plurality of accelerators arranged in a multi-tier architecture, wherein a primary accelerator is coupled between the processor and a plurality of secondary accelerators. The processor accesses at least one of the secondary accelerators by sending an instruction with ID field for the primary accelerator only. The primary accelerator selects one of the secondary accelerators according to an address stored in an address pointer register. The number of the accessible secondary accelerators depends on the address addressable by the address pointer register. The processor can also update or modify the address in the address pointer register by an immediate value or an offset address in the instruction.

This application claims the benefit of U.S. Provisional Application No. 60/751,626 filed Dec. 19, 2005.

### CROSS REFERENCE

This invention relates to the subject matter disclosed in a contemporaneously filed co-pending patent application Ser. No. 11/093,195 that is entitled “Digital signal system with accelerators and method for operating the same,” and is commonly assigned and incorporated herein by reference.

### BACKGROUND OF THE INVENTION

1. Field of the Invention

The present invention relates to a computer system, particularly a DSP (Digital Signal Processing) system, with a multi-tier accelerator architecture and a method for operating the same. Specifically, the invention relates to a computer system with a primary accelerator bridged between a processor and a plurality of secondary accelerators, wherein the primary accelerator facilitates the processor to access at least one secondary accelerator.

2. Prior art of the Invention

A processor such as a general-purpose microprocessor, a microcomputer or a DSP can process data according to an operation program. The modern electronic device generally distributes its processing tasks to different processors. For example, the mobile communication device contains (1) a DSP unit for dealing with digital signal processing such as speech encoding/decoding and modulation/demodulation, and (2) a general-purpose microprocessor unit for dealing with communication protocol processing.

The DSP unit may be incorporated with an accelerator to perform a specific task such as waveform equalization, thus further optimizing the performance thereof. U.S. Pat. No. 5,987,556 discloses a data processing device having an accelerator for digital signal processing. As shown in FIG. 1, the data processing device comprises a microprocessor core (DSP) 120, an accelerator 140 with an output register 142, a memory 112 and an interrupt controller 121. The accelerator 140 is connected to the microprocessor core 120 through data bus, address bus and R/W control line. The accelerator 140 is commanded by the microprocessor core 120, via the R/W control line, to read data from or write data to the microprocessor core 120 with a data address designated by the address bus. The disclosed data processing device uses the interrupt controller 121 to halt the data accessing between the accelerator 140 and the microprocessor core 120 when an interrupt request with high priority is sent to and acknowledged by the microprocessor core 120. However, because the microprocessor core 120 lacks the ability to identify different accelerators, the functionality of the data processing device is limited.

Accordingly, it is desirable to provide a DSP system capable of accessing different accelerators and requires no excessive instruction set coding space.

### SUMMARY OF THE INVENTION

The present invention is intended to provide a DSP system with the ability to access and identify a plurality of accelerators. Moreover, the present invention provides a DSP system with hierarchical accelerators to facilitate the selection of accelerators.

Accordingly, the present invention provides a DSP system with a primary accelerator bridged between a DSP processor and a plurality of secondary accelerators, wherein the primary accelerator facilitates the DSP processor to access at least one secondary accelerator.

In one aspect of the present invention, the primary accelerator is provided with an address pointer register. The secondary accelerators are associated with an address segment addressable by the address pointer register. If the DSP processor is intended to access a desired secondary accelerator, the DSP processor issues an L1 accelerator instruction containing L1 accelerator ID and accessing command. The primary accelerator will select the desired secondary accelerator according to a subset address in the address pointer register. The DSP processor can also issue the L1 accelerator instruction and an offset address to modify or update the contents in the address pointer register.

In another aspect of the present invention, the primary accelerator also sends control signals to the secondary accelerators for selecting a desired secondary accelerator, setting data transfer size, setting an accessing type, or indicating a parametric transfer mode.

### BRIEF DESCRIPTION OF THE DRAWINGS

FIG. 1 is a block diagram illustrating a data processing device having accelerator of a prior art.

FIG. 2 is a schematic diagram illustrating a multiple-tier accelerator architecture which is adopted by a DSP system according to an embodiment of the present invention.

FIG. 3 is a schematic diagram illustrating a Level-1 accelerator used in the multiple-tier accelerator architecture according to an embodiment of the present invention.

FIG. 4 is an exemplary illustrating an address map for three different Level-2 accelerators according to an embodiment of the present invention.

FIG. 5 is a signal waveform associated with an operation in the multiple-tier accelerator architecture according to an embodiment of the present invention.

FIG. 6 is a signal waveform associated with an operation in the multiple-tier accelerator architecture according to another embodiment of the present invention.

FIG. 7 is a signal waveform associated with an operation in the multiple-tier accelerator architecture according to another embodiment of the present invention.

FIG. 8 is a block diagram illustrating two Level-1 accelerators in parallel used in the multiple-tier accelerator architecture according to another embodiment of the present invention.

FIG. 9 is a flow chart illustrating an operating method of a multiple-tier accelerator architecture used in a DSP system according to an embodiment of the present invention.

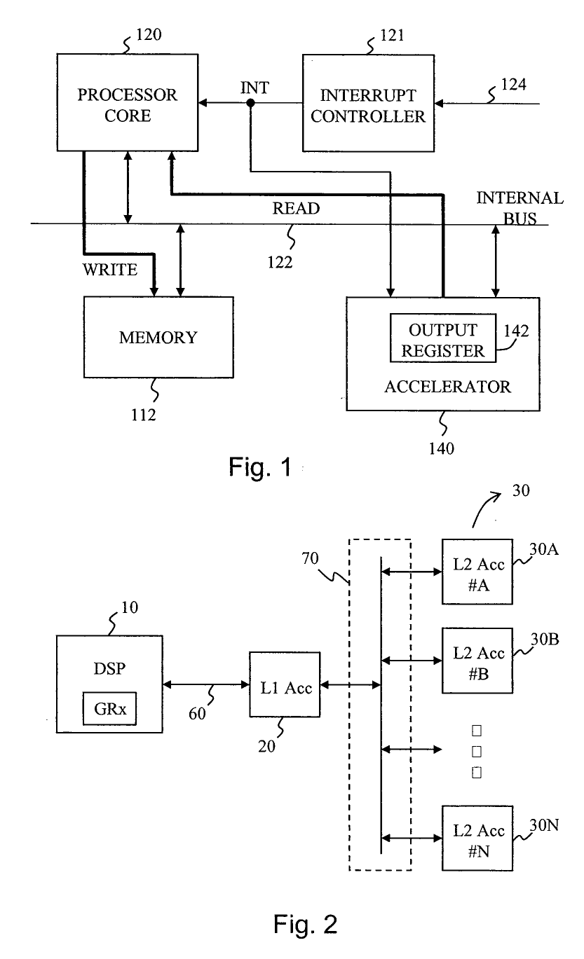

### DETAILED DESCRIPTION

FIG. 2 shows a multiple-tier accelerator architecture which is adopted by a DSP system according to an embodiment of the present invention. In this DSP system, a DSP processor 10 having a simple generic accelerator instruction set is connected to a Level-1 (L1) accelerator 20 through an accelerator interface 60. The L1 accelerator 20 is connected to a plurality of Level-2 (L2) accelerators 30A-30N through an accelerator local bus 70. The multiple-tier accelerator architecture comprises the L1 accelerator 20 and the L2 accelerators 30A-30N connected through the accelerator local bus system 70. For clarity, the Level-1 accelerator is used interchangeably with “the primary accelerator”, and the Level-2 accelerator is used interchangeably with “the secondary accelerator”.

This multi-tier accelerator architecture provides a number of advantages over a traditional approach of connecting an accelerator (or a number of accelerators) directly to the processor's (or DSP's) accelerator interface (or accelerator interfaces). For this traditional approach, refer for example to the way the MicroDSP1.x architecture supports multiple accelerators using up to four accelerator interfaces. One such advantage is that a small and generic L1 accelerator instruction set can be sufficient to support a multitude of L2 accelerators. Therefore, one does not have to define new accelerator instructions for every new L2 accelerator, while in the traditional approach one has to define a new accelerator instruction set for every new accelerator. Another advantage is that a large number of L2 accelerators can be supported, while the number of accelerators that can be supported by the traditional approach is much more limited. The large number of L2 accelerators is supported by applying standard memory mapped I/O techniques; one or more L1 32-bit address pointers are implemented into the L1 accelerator and all L2 accelerators are mapped into the created accelerator address space (addressable by the L1 accelerator address pointers) and accessible by the DSP using its generic L1 accelerator instruction set. Consequently, a smaller percentage of the DSP's instruction coding space is needed to support a large number of L2 accelerators. Together with the L1 accelerator, an L2 accelerator can be designed to replace an accelerator that uses the traditional approach. Simple single-cycle tasks (for example the reversing of a specified number of LSBs inside one of the DSP's registers) or more complex multi-cycle tasks (for example the calculation of motion vectors associated with a macro block of image data in MPEG-4 encoding) may be performed (started, controlled and/or monitored) by the DSP by issuing an L1 accelerator instruction, which will be forwarded by the L1 accelerator interface over the accelerator local bus to the appropriate L2 accelerator. Control and data information from the DSP to L2 accelerators and data information from L2 accelerators back to the DSP travel over the same interfaces and the same buses (the accelerator interface 60 and the accelerator local bus 70).

In this multiple-tier accelerator architecture, an accelerator ID is not necessary for the plurality of L2 accelerators 30A to 30N and the coding space of the DSP instruction set can thus be utilized efficiently. For example, in the MicroDSP.1.x instruction set if 4 bits are used to denote an L1 accelerator ID, then 1/16 (˜6%) of the entire instruction set coding space would be sufficient to support all hardware accelerators, while 15/16 (˜94%) of the entire instruction set coding space could be used for the DSP core's internal instruction set. The accessing (reading/writing) of the L2 accelerators 30A to 30N is performed through an address pointer register in the L1 accelerator 20 and an offset address provided by the DSP processor 10.

Each of the L2 accelerators 30A to 30N is assigned with an address segment, which is a subset of the total accelerator address space addressable by the L1address pointer register in the L1 accelerator 20. The L1 accelerator 20 first identifies the L1 accelerator ID in an instruction sent from the DSP processor 10. If the L1 accelerator ID of predetermined bit width (for example, 4-bit) is present in the instruction, then the instruction is conceived as an accelerator instruction by the L1 accelerator 20.

Alternatively, the L1 accelerator 20 will locally update its own contents, such as modify its L1 address pointer register, according to the accelerator instruction. In the case of accessing an L2 accelerator 30, the L1 accelerator 20 drives the accelerator local bus signals according to the accelerator instruction. The local bus address is driven either directly by the contents of the L1 address pointer register or by a combination of the contents of the L1 address pointer register and the information provided by the accelerator instruction. In the case of changing the contents in the L1 address pointer register, its contents are updated or modified by a value contained in the L1 accelerator instruction.

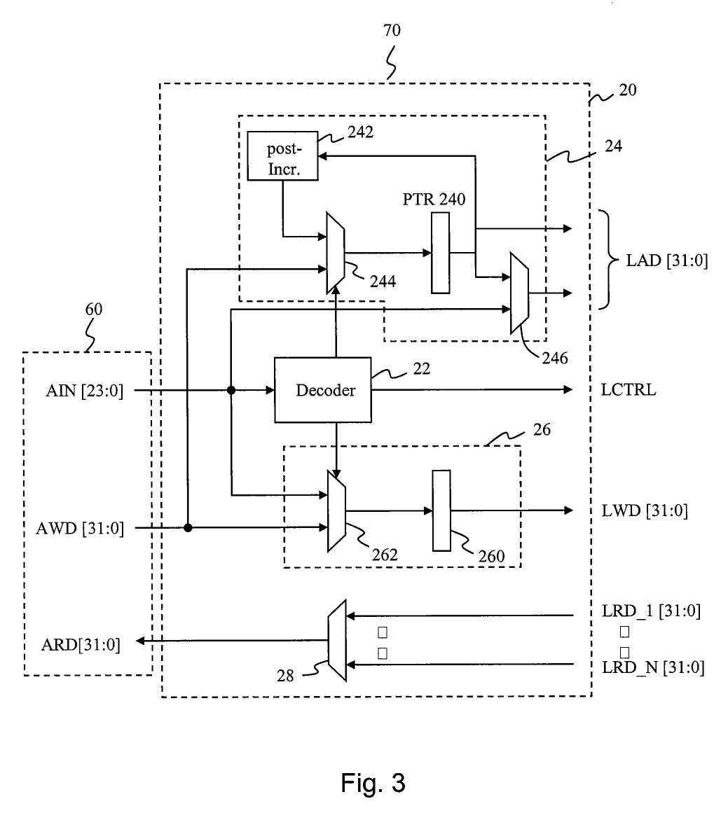

FIG. 2 and FIG. 3 show schematic diagrams of the L1 accelerator 20 used in a preferred embodiment of the present invention. The L1 accelerator 20 is connected to the DSP processor 10 via the accelerator interface bus 60. The accelerator interface bus 60 comprises a 24-bit accelerator instruction bus AIN [23:0], a 32-bit L1 write data bus AWD [31:0], and a 32-bit L1 read data bus ARD [31:0]. The bus widths used in the instruction bus and the data bus are just illustrative and do not limit the scope of the present invention. Other bus widths can also be used for practical system requirement.

The L1 accelerator 20 is connected to the plurality of L2 accelerators 30A to 30N through the accelerator local bus 70. The accelerator local bus 70 comprises a 32-bit address bus LAD [31:0], a control bus LCTRL, a 32-bit L2 write data bus LWD [31:0], and a plurality of 32-bit L2 read data buses LRD [31:0].

As also shown in this FIG. 3, the L1 accelerator 20 comprises (1) a decoder 22 for receiving an instruction from the DSP processor 10 through the AIN bus and decoding the received instruction, (2) an address generator 24 commanded by the decoder 22 for outputting an L2 address onto the LAD bus, (3) a write buffer 26 commanded by the decoder 22 for providing buffering between the AWD bus and the LWD bus, and (4) a read multiplexer 28 to multiplex between all LRD buses driven by a plurality of L2 accelerators 30. The address generator 24 comprises a 32-bit L1 address pointer register (PTR) 240 for storing a 32-bit address. The write buffer 26 comprises a 32-bit write data register 260. Depending on the L1 accelerator ID, the received instruction can be identified as an accelerator instruction.

According to one embodiment of the present invention, accessing to the plurality of L2 accelerators 30A-30N is identified by the LAD address generated by the address generator 24. The LAD address may be generated by driving the contents of the address pointer register 240 onto LAD[31:0], or by concatenating an MSB portion of the address pointer register 240 with a number of address bits provided by the accelerator instruction used as a page-mode immediate offset address. The address pointer register 240 may be post-incremented if indicated by the accelerator instruction. The address generation and optional pointer post-modification is controlled by the decoder 22 The decoder 22 also drives the control signals of the LCTRL that control the L2 accelerator 30 access to be performed as indicated by the accelerator instruction.

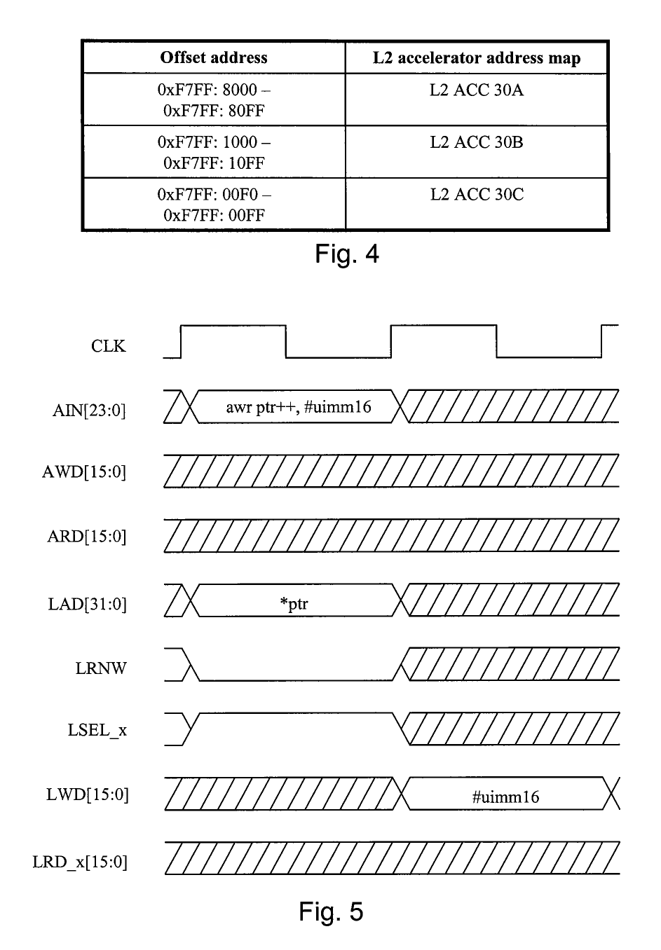

FIG. 4 shows an exemplary address map for three different L2 accelerators 30A, 30B and 30C. Accelerator tasks provided by the L2 accelerators 30A-C can be controlled and monitored by the DSP 10 by sending appropriate accelerator instructions to the L1 accelerator 20, which will forward control and data information to the appropriate address locations in the L2 accelerators 30. Optionally, the L1 accelerator 20 can transfer data between the DSP 10 and an L2 accelerator 30x in any direction, or in both directions concurrently, in association with an accelerator instruction.

The contents of the PTR 240 can be assigned or updated by following two exemplary L1 accelerator instructions:

1. “awr ptr.hi, #uimm16”

This L1 accelerator instruction writes a 16-bit unsigned immediate value #uimm16 to the high 16 bits of the L1 address pointer register PTR 240 in the L1 accelerator 10.

2. “awr ptr.lo, #uimm16”

This L1 accelerator instruction writes a 16-bit unsigned immediate value #uimm16 to the low 16 bits of the L1 address pointer register PTR 240 in the L1 accelerator 10.

The “immediate value” means that this value is directly encoded into the L1accelerator instruction. For example, the 24-bit L1 instruction can be in the following form:

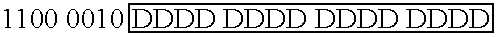

wherein the first 4 bits indicate an L1 accelerator ID and “D” in the frame means the 16-bit unsigned immediate value.

According to the above address-assigning instructions, the contents of the PTR 240 in the L1 accelerator 10 can be advantageously set to select a desired L2 accelerator 30x for data accessing.

For the DSP processor 10, data access operations to L2 accelerators 30 over the accelerator local bus 70 may be achieved according to the following two examples, wherein each example has an exemplary instruction and an associated signal waveform.

### EXAMPLE 1

### Writing Data to L2 Accelerator 30A With Post-Increment of PTR 240

The exemplary L1 instruction is “awr ptr++, #uimm16”

This L1 instruction writes a 16-bit unsigned immediate value to the L2 accelerator address given by PTR 240. Afterwards, the address in the PTR 240 is post-incremented by one. For example, if the content of the PTR 240 is 0xF7FF:8000, this command issued from the DSP processor 10 can successively write blocks of 16-bit unsigned data to the internal input registers of the L2 accelerator 30A.

FIG. 5 shows a signal waveform associated with a write operation from the DSP 10 to an L2 accelerator 30. The set of signals beginning with capital letter A indicates the signals associated with the accelerator interface bus 60 between the DSP processor 10 and the L1 accelerator 20, while the other data and control signals are associated with the accelerator local bus system 70. The LAD[31:0] is a 32-bit bus driven by the L1 accelerator 20 during the control phase The LRNW suggests that it is a read-not-write signal. The LSEL_x is a select signal that indicates an L1 accelerator 20's access to one of the L2 accelerators over the accelerator bus. In the diagram, *PTR indicates that the value in the L1 accelerator address pointer PTR 240 is driven onto LAD[31:0]. LSEL_x is a select signal to one of the L2 accelerators. Only one of the L2 accelerators 30A to 30N can be actively selected at any given time and the selection depends on some number of MSBs of the address present on LAD[31:0]. The selected L2 accelerator 30, as selected by the active LSEL_x signal, decodes the signals on the accelerator local bus 70 and writes the #uimm16 data to one of its internal input registers as selected by some number of LSBs of the address present on LAD[31:0]. In this figure, the LSEL_x and LRNW signals are conveyed through control bus LCTRL.

With reference again to FIG. 3, the address generator 24 comprises (1) a post-increment unit 242 for performing a post-increment operation to the address in the PTR 240, (2) a first multiplexer 244 for selectively sending the output from the post-increment unit 242 and the data of the AWD [31:0] to the PTR 240, under the control of the decoder 22. Therefore, the content of the PTR 240 can be modified. The address generator 24 can further comprise a second multiplexer 246 for selectively sending an LSB portion from the PTR 240 or some portion from the instruction bus AIN [23:0] onto an LSB portion of the address bus LAD [31:0]. With reference to FIG. 3, the write buffer 26 comprises a third multiplexer 262 and a write data register 260; LWD[31:0], driven by the write data register 260, may consist of a combination of data from the instruction bus AIN [23:0] and the write data bus AWD [31:0]. The decoder 22 sends a data size signal LSIZE through the control bus LCTRL. The data size signal LSIZE indicates a 1-byte, 2-byte or a 4-byte data transfer over the accelerator local bus 70.

The instruction in this example can be implemented as a 2-stage pipeline process. During the first cycle (decode cycle), the L1 instruction is sent from the DSP 10 on the instruction bus AIN [23:0]; and LAD[31:0] and LCTRL are driven according to the specification of the accelerator instruction. During the second cycle (execute cycle), the 16-bit unsigned data is driven onto the low 16 bits of the write data bus LWD [31:0], namely LWD [15:0].

### EXAMPLE 2

### Moving Data From L2 Accelerator 30A to the Internal Register of the DSP Processor 10

The exemplary L1 instruction is “ard GRx, #addr8”

This L1 instruction moves the data from an L2 accelerator to an internal register GRx (a 16-bit register) of the DSP processor 10, wherein a specific L2 accelerator address is designated by the concatenation of PTR [31:8] and #addr8 (an 8-bit immediate address value)

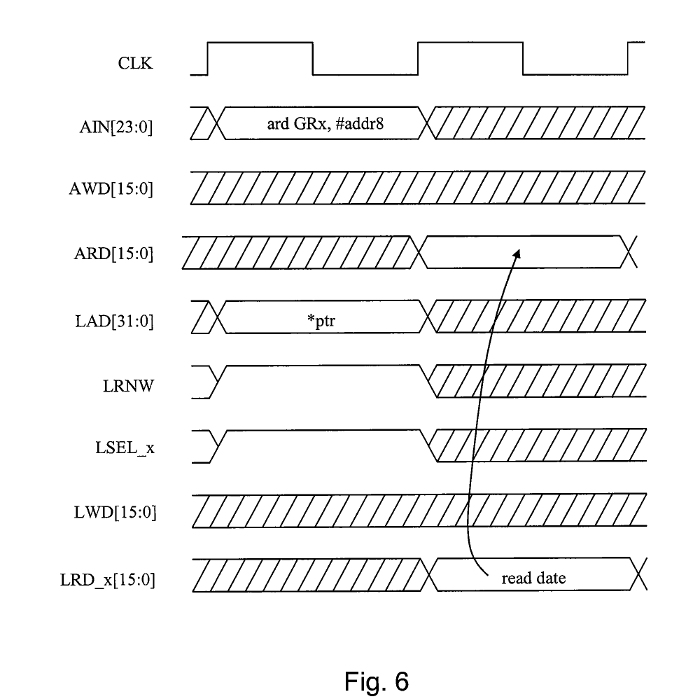

FIG. 6 shows the signal waveform associated with this operation. LSEL_x is a selection signal to one of the L2 accelerators. Only one of the L2 accelerators 30A to 30N can be active at a given time and the selection depends on the address value present on LAD[31:0]. The selected L2 accelerator will drive the contents in one of its internal registers selected by some LSB portion onto the LRD bus back to the L1 accelerator 10. The LSB portion of LAD bus is driven by the offset address “#addr8” sent by the DSP processor 10. The L1 accelerator 10 will forward the read data back to the internal register GRx of the DSP processor 10 on the accelerator interface ARD bus. The read data is written into the internal register GRx of the DSP 10.

With reference again to FIG. 3, a multiplexer 28 is used for selecting the appropriate read data bus output from the plurality of read data buses LRD_A to LRD_N corresponding to the L2 accelerators 30A to 30N. The selected LRD_x is driven onto the ARD read data bus and the selection complies with the L2 selection signal LSEL_x.

For example the above-mentioned 24-bit L1 instruction can be in the following form:

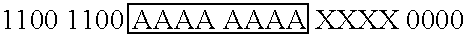

wherein the bits denoted with letter “A” indicate the 8-bit immediate value for offset address #addr8 sent by the processor 10. Bits denoted with letter “X” indicate one out of 16 possible general register GR0-GR15 inside the processor 10.

As can be seen in the previous two examples, no accelerator ID is assigned to any of the L2 accelerators. Instead, a flexible address generator 24 is used inside the L1 accelerator to select between the L2 accelerators and destinations within any L2 accelerator. The bit number of the PTR 240 can also be modified (other than 32) to designate a smaller or a larger L2 accelerator address space.

In above two examples, only 4 bits (such as the beginning bit sequence 1100 in the exemplary) are used for L1 accelerator ID. The L1 instruction set may be limited to a relatively small number (32 or less) of generic instructions. The L1 instruction set may also be flexible enough to support a large number and a wide variety of L2 accelerators. The next example illustrates the flexibility of a generic and yet powerful L1 accelerator instruction.

### EXAMPLE 3

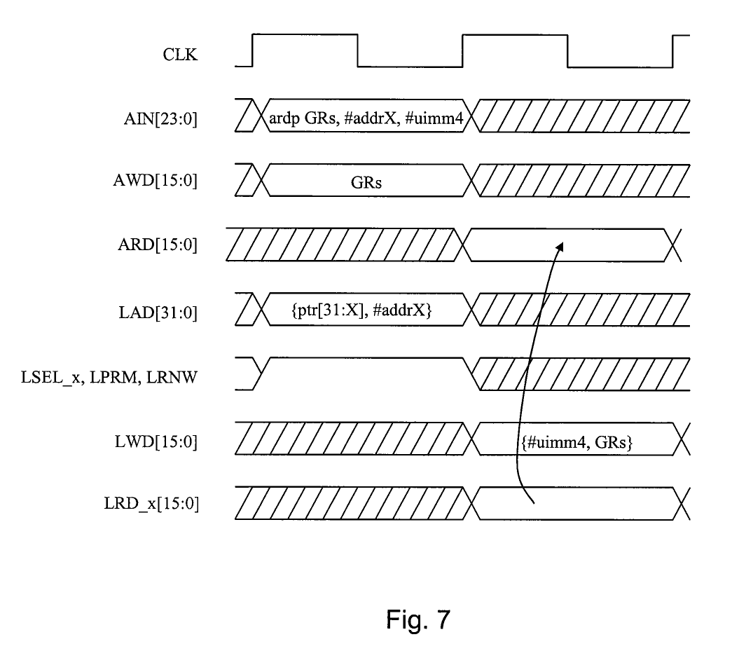

### Parameter-Controlled Write-Read Operation to/from an L2 Accelerator Address (referring to FIG. 7)

The generic L1 instruction is “ardp GRx, #addrX, #uimm4”

This L1 instruction sends the data stored in the internal register GRx of the DSP processor 10 to the L2 accelerator address designated by the concatenation of PTR[31:X] and the X-bit immediate offset address #addrX. The contents of GRx are driven by the DSP onto AWD[15:0] and forwarded by the L1 accelerator onto LWD[15:0] in the next (execute) clock cycle. Similarly, a 4-bit immediate parameter value driven by the DSP and reside on AIN[23:0] is forwarded by the L1 accelerator onto LWD[19:16] in the next (execute) clock cycle. Moreover, the L1 instruction also instructs the selected L2 accelerator to drive some 16-bit data to its associated LRD_x[15:0] in the execute clock cycle which will update the GRx register at the end of the execute cycle. Note that this accelerator instruction utilizes both the write and read data buses. Also note that the use of the 4-bit parameter value is entirely defined by the L2 accelerator; its use is not limited by the definition of the L1 accelerator instruction itself. The accelerator local bus signal LPRM is active (high) during the decode cycle to indicate that this type of instruction is occurring over the accelerator local bus.

The L1 accelerator instruction may be used to implement different single-cycle tasks inside one or multiple L2 accelerators. As an example, when being sent to a specific L2 accelerator address, this instruction can mean that some number of LSBs (given by the 4-bit parameter value) of the 16-bit contents of DSP register GRx should be bit-reversed. The same instruction can mean completely different operations on the data provided on LWD[15:0] (or, optionally, some operation on the data that is stored at that specific L2 accelerator address location), and that the result of this operation shall be clocked into DSP register GRx at the end of the execute cycle.

FIG. 7 shows the signal waveform associated with this L1 accelerator instruction. The signals beginning with capital A are associated with the accelerator interface bus system 60 between the DSP processor 10 and the L1 accelerator 20. The other data and control signals beginning with a capital L are associated with the accelerator local bus system 70.

In FIGS. 6 and 7, the LSEL_x, LPRM and LRNW signals are conveyed through control bus LCTRL. The LSEL_x signal is an active selection signal for one of the L2 accelerators. The LPRM signal is parameter indication signal, wherein a logical one on this signal indicates a write-read transaction controlled by a parameter over the LWD[19:16] bus. The LRNW signal indicates a toggle between reading and writing transaction. A logical one on this signal indicates a read transaction while a logical zero on this signal indicates a write transaction over the accelerator local bus system 70.

In one example, if the system is a JPEG decoding system, the L2 accelerators can be a Variable Length Decoder (VLD) 30A, a DCT/IDCT Accelerator 30B and a Color Conversion Accelerator 30C.

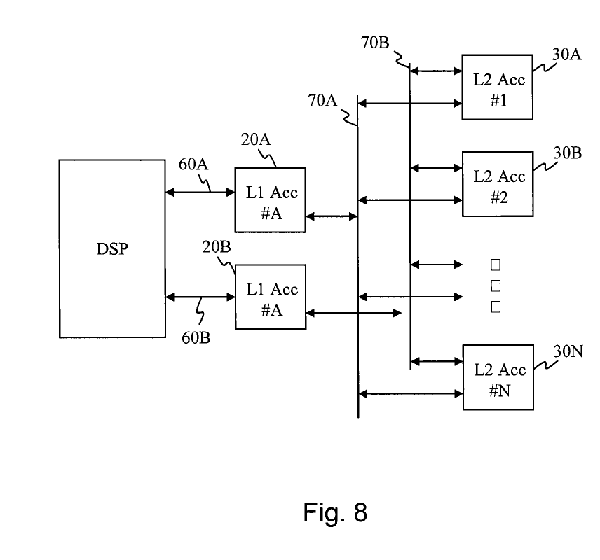

FIG. 8 shows a schematic diagram of a DSP system adopting the multiple-tier accelerator architecture according to another preferred embodiment of the present invention. The proposed architecture can be is a DSP that is capable of issuing accelerator instructions in parallel. FIG. 8 shows a DSP processor 10 that can issue two accelerator instructions (Level-1) in parallel. In this case, one or two Level-2 accelerators 30A to 30N that can be accessed by two accelerator instructions in parallel need to provide two accelerator local bus systems 70A and 70B.

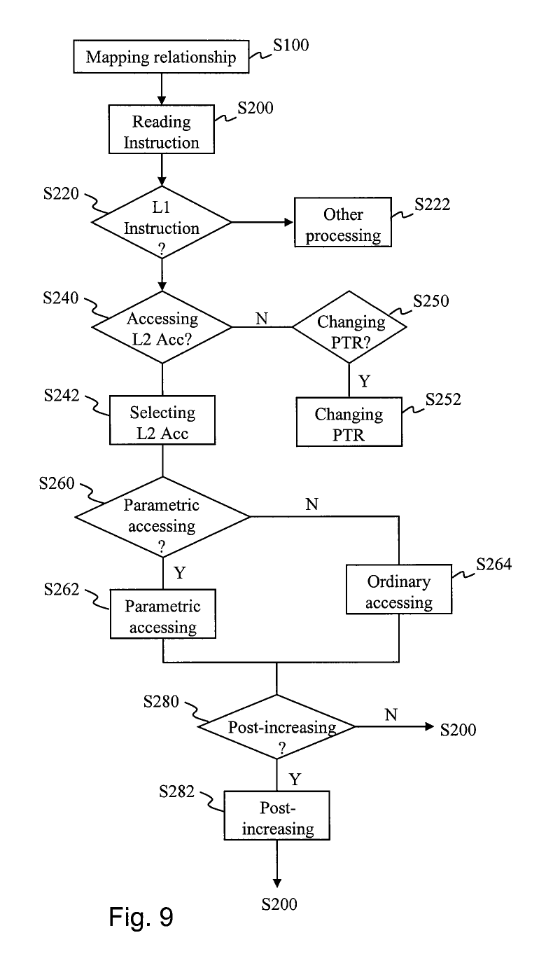

The operation of the L1 accelerator proposed in the present invention can be summarized by the flow chart shown in FIG. 9. The method provides instruction identification between a processor and a plurality of L2 accelerators bridged by an L1 accelerator.

At the first step S100, a mapping relationship between the subset address of the L1 accelerator address pointer PTR and the L2 accelerators connected to the L1accelerator is established.

At next step S200: an instruction is read from the DSP processor 10.

At next step S220: Identifying whether the instruction is an L1 accelerator instruction by examining the presence of the L1 accelerator ID. If the instruction is not an L1 instruction, step S222 is then executed, otherwise, step S240 is executed.

At step S222: The instruction is executed internally in the DSP processor 10 and may perform access to some other devices connected to the DSP processor, such SRAM memory (not shown).

At next step S240: Identifying whether the L1 instruction is intended to access an L2 accelerator. If true, step S242 is executed; if not, step S250 is executed.

At step S242: an L2 accelerator designated by the address in the PTR 240 is selected and then proceeding to next step S260.

At step S250: Identifying whether the L1 instruction is intended to modify the address in the PTR 240, if true, step S252 is executed.

At step S252: Modifying the address in the PTR 240 according to information contained in the L1 accelerator instruction.

At next step S260: Identifying whether the accessing to the L2 accelerator relates to a parametric controlled accessing. If true, a step S262 is executed, otherwise step S264 is executed.

At step S262: Performing data accessing to the L2 accelerator with parametric controlled accessing, which is performed with reference to the description of example 3. Afterward, step S280 is executed.

At step S264: Performing data accessing to the L2 accelerator, which can be performed with reference to the description of examples 1 and 2. Afterward, step S280 is executed.

At next step S280: Examining whether a post-increment should be performed. If true, the post-increment step is executed in a following step S282; otherwise, the procedure is back to the step S200.

To sum up, the present invention has the following advantages:

1. The accelerator instruction set provided by the Level-1 accelerator is designed once only and is used by the DSP to communicate with all Level-2 accelerators. Hence, there is no need to redesign or duplicate accelerator instruction set for a Level-2 accelerator. The assembly tool need not be updated for new Level-2 accelerators.

2. All Level-2 accelerators are controlled through the generic Level-1 instruction set instead of dedicated accelerator instruction sets. Therefore the Level-2 accelerators do not have any instruction code dependencies, which simplifies their design and their reusability in the future DSP subsystems.

3. The internal address pointer register in the Level-1 accelerator can support a large number of Level-2 accelerators. Level-2 accelerators need not be clustered and aggregated in one point inside the Level-1 accelerator. The support for a large number of Level-2 accelerators simplifies design partitioning and reusability.

4. When a single L1 accelerator is used, an accelerator ID is not necessary and the DSP instruction set coding space can be utilized efficiently. Assuming that 4 bits are used to denote a Level-1 accelerator ID for a 24-bit instruction, then 1/16 (˜6%) of the entire 24-bit instruction set coding space is sufficient to support all hardware accelerators, while 15/16 (˜94%) of the entire instruction set coding space can be used for the DSP core instruction set.

Although several embodiments are specifically illustrated and described herein, it will be appreciated that modifications and variations of the present invention are covered by the above teachings and within the purview of the appended claims without departing from the spirit of the present invention.

What is claimed is:

1. A computer system with a multi-tier accelerator hierarchy sharing a common accelerator instruction set, comprising:
a processor sending an instruction chosen from said common accelerator instruction set;
a primary accelerator connected to said processor for receiving said instruction; and
a plurality of secondary accelerators connected to said processor through said primary accelerator;
wherein said primary accelerator comprising:
an address generator comprising a primary address set; and
a decoder configured to control said address generator for generating a secondary address corresponding to a selected secondary accelerator according to said instruction and a primary address in said primary address set.

2. The computer system as in claim 1, wherein said address generator further comprises an address pointer register for storing said primary address set.

3. The computer system as in claim 1, wherein said selected secondary accelerator corresponding to said secondary address performs the operation indicated by said instruction through the control of said primary accelerator.

4. The computer system as in claim 3, wherein said decoder is configured to send a combination of the following signals to said selected secondary accelerators:
a control signal for setting said selected secondary accelerator to be active;
a data size signal indicating the data size to be accessed;
a parameter control signal indicating a parameter-controlled operation; and
an access signal indicating a read or a write operation.

5. The computer system as in claim 4, wherein said parameter control operation is configured to write a value in said instruction to said selected secondary accelerator and to read data in said selected secondary accelerator in a single clock cycle.

6. The computer system as in claim 1, wherein said secondary address can be generated as a combination of the following elements:
said primary address concatenated with an offset address in said instruction;
said primary address modified with said offset address in said instruction; and
a subset of said primary address within an address segment assigned to said selected secondary accelerator.

7. The computer system as in claim 1, wherein said primary accelerator is connected to said processor through an instruction bus, and said primary accelerator is connected to said secondary accelerators through an address bus and a control bus.

8. A primary accelerator bridged between a processor and a plurality of secondary accelerators sharing a common instruction set, said primary accelerator comprising:
an address pointer register comprising an address having an address segment assigned to a selected secondary accelerator; and
a decoder for receiving an instruction sent from said processor and configured to control said address pointer register.

9. The primary accelerator as in claim 8, further comprising:
a multiplexer configured to selectively sending said address and a portion of said instruction to said selected secondary accelerator;
a post-increment unit configure to perform a post-increment operation to said address in response to the completion of the instruction.

10. The primary accelerator as in claim 8, further comprising:
a data buffer connected between said processor and said selected secondary accelerator for buffering the data access.

11. The primary accelerator as in claim 8, wherein said decoder is configured to modify said address with an offset address in the instruction.

12. The primary accelerator as in claim 11, wherein said decoder is configured to concatenate said address with said offset address.

13. The primary accelerator as in claim 8, wherein said decoder is configured to access an internal register in said selected secondary accelerator according to said address.

14. The primary accelerator as in claim 8, wherein said decoder is configured to write an immediate data contained in said instruction to said selected secondary accelerator.

15. The primary accelerator as in claim 8, wherein said decoder is configured to send a combination of the following signals to said selected secondary accelerator:
a control signal for setting said selected secondary accelerator to be active;
a data size signal indicating data size to be accessed;
a parameter control signal indicating a parameter-controlled operation; and
an access signal indicating a read or a write operation.

16. The primary accelerator as in claim 15, wherein the parameter-controlled operation takes a single clock cycle.

17. The primary accelerator as in claim 8, wherein said primary accelerator is connected to said processor through an instruction bus and a first data bus, and said primary accelerator is connected to said secondary accelerators through an address bus, a control bus and a second data bus.

18. A method for operating a system with multi-tier accelerator hierarchy comprising a processor and a plurality of accelerators sharing a common instruction set, comprising the steps of:
mapping said plurality of accelerators to an address set;
receiving an instruction chosen from said common instruction set from said processor with a field corresponding to an address in said address set; and
accessing one of said accelerators corresponding to said address.

19. The method for operating the system as in claim 18, wherein the step of accessing further comprising a step of:
providing a control signal to said accelerator according to said instruction.

20. The method for operating the system as in claim 19, wherein said control signal is a combination of the following elements:
an active control signal for setting a selected accelerator to be active;
a data size signal indicating data size to be accessed;
a parameter control signal indicating a parameter control operation; and
an access signal indicating a read or a write operation.

21. The method for operating the system as in claim 18, further comprising a step of:
increasing said address in response to said accessing step.

22. The method for operating the system as in claim 18, further comprising a step of modifying said address in said address set according to an offset contained in said instruction.
